(19) United States
(12) Patent Application Publication
(10) Pub. No.: US 2014/0225902 A1
(43) Pub. Date: Aug. 14, 2014

(54) IMAGE PYRAMID PROCESSOR AND METHOD OF MULTI-RESOLUTION IMAGE PROCESSING

(71) Applicant: NVIDIA CORPORATION, Santa Clara, CA (US)

(72) Inventors: Qiuling Zhu, Pittsburgh, PA (US); Navjot Garg, Santa Clara, CA (US); Yun-Ta Tsai, Santa Clara, CA (US); Kair Pulli, Santa Clara, CA (US); Albert Meixner, Mountain View, CA (US)

(73) Assignee: NVIDIA CORPORATION, Santa Clara, CA (US)

(21) Appl. No.: 13/764,416

(22) Filed: Feb. 11, 2013

(51) Int. Cl. G06T 1/00

(52) U.S. Cl. CPC G06T 1/00
USPC 345/501

(57) ABSTRACT

An image pyramid processor and a method of multi-resolution image processing. One embodiment of the image pyramid processor includes: (1) a level multiplexer configured to employ a single processing element to process multiple levels of an image pyramid in a single work unit, and (2) a buffer pyramid having memory allocable to store respective intermediate results of the single work unit.

### TECHNICAL FIELD

This application is directed, in general, to computer vision and, more specifically, to multi-resolution image pyramid processing.

### BACKGROUND

Computer vision is a technology that seeks to replicate human vision by electronically perceiving and understanding an image. Computer vision is found in a variety of industrial and consumer applications, including: manufactured product inspection, artificial intelligence, autonomous navigation, face recognition and handwriting recognition. A prolific example is the digital camera found in nearly all modern cellular phones and mobile computing devices. Some applications of computer vision are considered non-real-time, like handwriting recognition, where an image can be processed without constraint. Some applications are considered low-power, such as facial recognition in digital cameras. Many applications are real-time where an image must be interpreted into useful data and acted upon almost instantaneously. An example of real-time computer vision may be an autonomous navigation device that visually perceives its position, trajectory and environment and generates control commands to its host vehicle, whether it is an automobile, airplane, or rocket, to reach some target destination. These real-time and low-power computer vision applications demand efficient processing of large amounts of data in a short time and at a minimum cost; a demand often met by using hardware acceleration.

Computer vision processing is often divided into two stages: front-end processing and high-level interpretation. Of these, front-end processing, sometimes known as “pre-processing,” is more amenable to hardware acceleration. Front-end processing includes signal-level analysis functions that are relatively simple, data-intensive and generic to many different applications. Processing steps are carried out at each sample position over broad areas of the scene and extended periods of time. For these reasons, front-end processing tends to consume more time and energy than high-level interpretation.

Amplifying the real-time and low-power demands is the image pyramid data structure. The image pyramid is a basic data structure for multi-resolution images that provides a hierarchical framework to implement multi-resolution algorithms. The framework provides a scaled representation of the source image that supports fast search and multi-resolution computer vision algorithms. The hierarchical nature of the image pyramid makes it ill-suited for conventional single-instruction, multiple-data (SIMD) mesh or pipeline processing architectures. In image pyramid processing, the pixels of an image pyramid are recursively processed and up-sampled or down-sampled to create an increasingly finer or coarser image for interpretation. Front-end processing, for instance, carries out basic signal-level operations, or “atomic” operations, on each pixel in each resolution level of the image pyramid, including: addition, subtraction, convolution, feature detection, descriptor generation, motion estimation and image warping. As processing progresses to each sub-level of the image pyramid, from coarse-to-fine, the resolution increases, along with the volume of data. Alternatively, the processing may progress from fine-to-coarse, where the resolution decreases with the volume of data. The data forms a pyramid of image data from which actionable numeric and symbolic information may be extracted using various theories of geometry, physics and statistics, among others.

For example, motion analysis may be performed at a reduced resolution to produce a fast and inexpensive coarse estimate of displacement between two frames, and then repeated and refined at successively higher resolutions until a desired precision is achieved. The motion analysis at each level yields an increasingly larger data set that can be used in higher-level interpretation processes.

Due to the inadequacy of SIMD and pipeline architectures, specialized architectures have been developed to provide the hardware acceleration demanded by many computer vision applications. Front-end processes are decomposed into a series of atomic functions to be carried out by processing elements, like those mentioned above. Within that data flow, line buffers provide an interface between image pyramid levels. The interface is needed because of the necessarily different data rates at each level.

One example of hardware acceleration for image pyramid processing is a linear pipeline architecture. According to this architecture, each level of the image pyramid is processed by a separate processing element and allocated a line buffer in memory. The levels are processed sequentially, moving the output data of one level into the line buffer and retrieving it for processing the next. The coarser levels of the image pyramid require smaller line buffers than the finer, because less data exists at the coarser levels, which comprise fewer pixels. Consequently, the coarser levels of the image pyramid may be processed in less time than the finer levels.

A segmented pipeline is an alternate to the linear pipeline architecture. According to this architecture, a single processing element is used for all levels of the image pyramid. The results of computations at one level are written to memory until that level is complete, at which point the results are read from memory for processing the next level.

### SUMMARY

One aspect provides an image pyramid processor, including: (1) a level multiplexer configured to employ a single processing element to process multiple levels of an image pyramid in a single work unit, and (2) a buffer pyramid having memory allocable to store respective intermediate results of the single work unit.

Another aspect provides a method of multi-resolution image processing, including: (1) carrying out an operation on a first resolution level pixel of an image pyramid during a first processing cycle and storing results in a pyramid buffer, and (2) employing the results in carrying out the operation on a second resolution level pixel related to the first resolution level pixel during a second processing cycle.

Yet another aspect provides a computer vision engine, including: (1) a processing engine pool having a processing element operable to carry out an operation on pixels within a multi-level work unit of an image pyramid, (2) a control block configured to direct the processing element to process the multi-level work unit completely before processing another multi-level work unit, and (3) a buffer pyramid configured to store respective intermediate results generated by the processing element.

### BRIEF DESCRIPTION

Reference is now made to the following descriptions taken in conjunction with the accompanying drawings, in which:

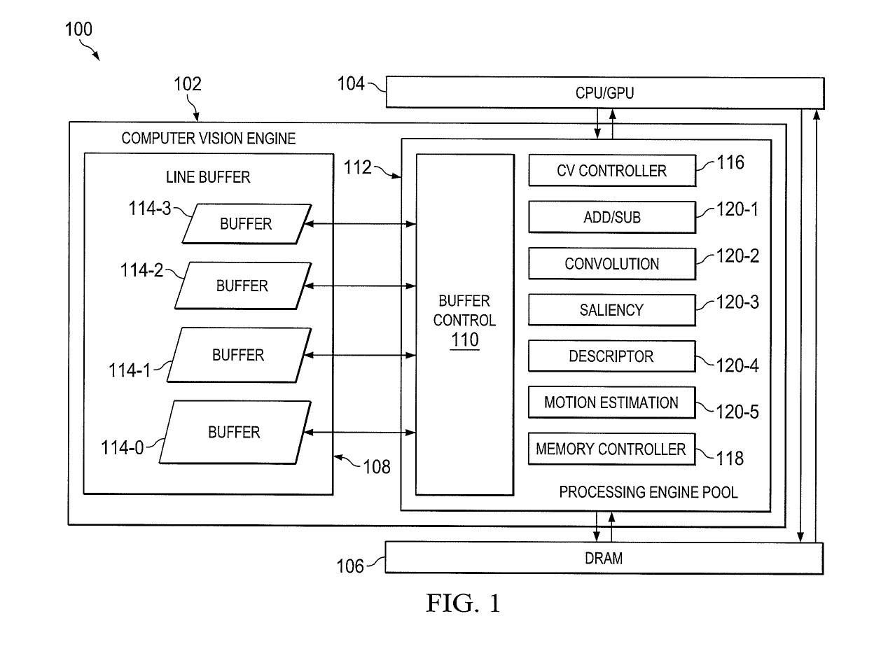

FIG. 1 is a block diagram of a computing system within which a computer vision engine or method of multi-resolution image processing may be embodied or carried out;

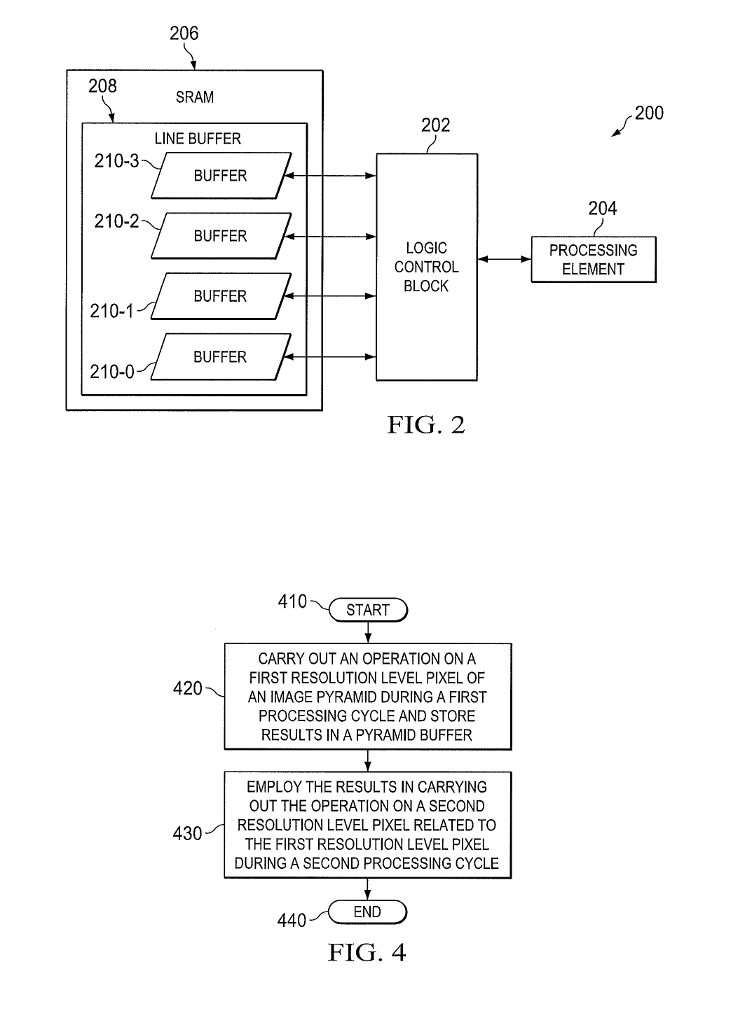

FIG. 2 is a block diagram of one embodiment of an image pyramid processor;

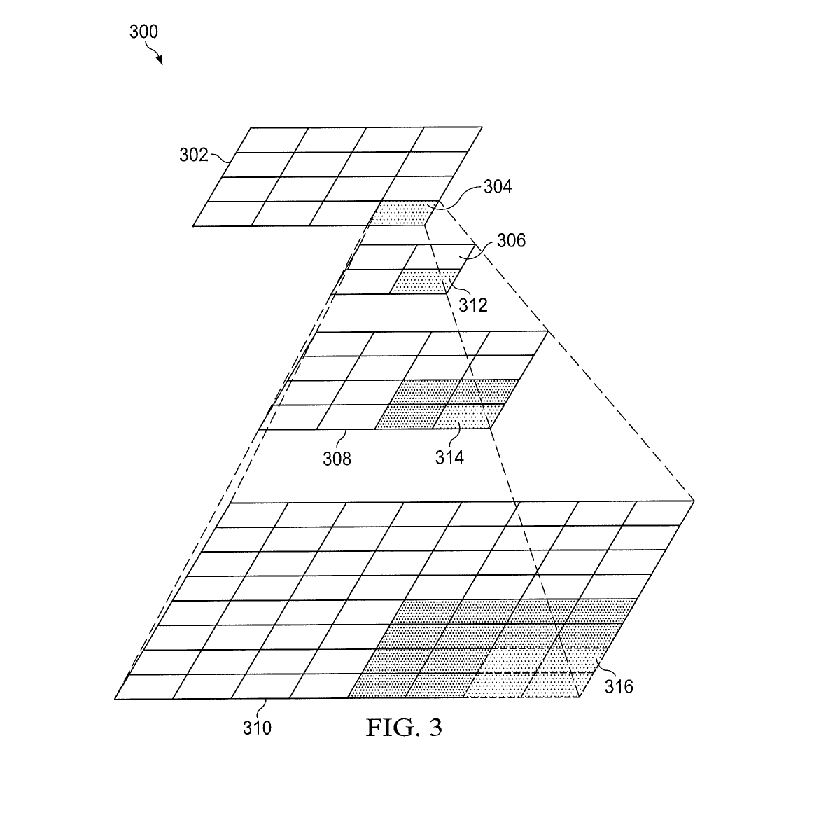

FIG. 3 is an illustration of one embodiment of a work unit within an image pyramid; and

FIG. 4 is a flow diagram of one embodiment of a method of multi-resolution image processing.

### DETAILED DESCRIPTION

Specialized architectures are prevalent in many computer vision systems, or “engines.” The specialization is a necessary consequence of the image pyramid data structure often employed by computer vision technology. The image pyramid presents the source image in a framework that is amenable to efficient accessibility and processing. However, conventional SIMD and pipeline architectures are ill-suited for processing such a data structure. It is realized herein that certain specialized architectures fail to use computer vision engine computational resources efficiently and are therefore relatively slow and power-consumptive.

It is realized herein that the linear pipeline architecture for image pyramid processing under-utilizes computational resources. The architecture employs duplicate processing elements that operate on the various levels of the image pyramid. The image pyramid architecture dictates that coarse levels of the pyramid comprise fewer pixels and less data than finer levels. To maintain a synchronized processing flow between levels, processing elements operating on the more coarse levels must operate at a reduced clock rate. It is realized herein that the slower clocked processing elements constitute an under-utilization of computational resources.

It is also realized herein that the segmented pipeline architecture avoids under-utilization of computational resources but sacrifices efficient memory usage for speed. The segmented pipeline architecture uses a single processing element that processes a level of the image pyramid completely before proceeding to the next. Results of processing a particular level are moved into the line buffer memory allocated in static random access memory (SRAM). SRAM is a necessary intermediate between a computer vision engine and main memory, which is most often allocated in dynamic random access memory (DRAM). DRAM tends to be relatively cheap but is not as fast and consumes more power than SRAM. For these reasons, SRAM is often used at a premium and in limited capacity. To sustain the processing load, processing elements of a computer vision engine operate only on data that has been moved from DRAM to the line buffer or data that was written directly to the line buffer. As a level of the image pyramid is processed and the results written to the line buffer, the volume of data quickly exceeds the capacity of the allocated SRAM. As the processing flow transitions from one level to the next, the intermediate results are moved to main memory in DRAM and later retrieved from main memory when the data is needed to process the next level of the image pyramid. It is realized herein that such heavy memory traffic to and from main memory introduces latency and wastes power.

It is further realized herein that a time-sharing pipeline architecture for image pyramid processing yields good computational resource utilization, fast processing and efficient use of memory. It is realized herein that by organizing the processing task into multi-resolution work units based on pixels on the coarsest level of the image pyramid and processing the data in a time-shared manner among the image pyramid levels, the architecture needs a single processing element and a minimally sized line buffer to complete the processing task. Several processing tasks can be combined to form a pipeline that achieves a higher level effect. For instance, a Laplacian pyramid can be constructed via the combination of processing elements for addition, subtraction and convolution. A single work unit flows through the pipeline while each of the processing elements performs its function in parallel. The processing task is arranged in as many work units as there are pixels at the coarsest image pyramid level. The processing element may be clocked at its highest rate and the line buffer is allocated enough SRAM to concurrently store the intermediate results of processing each level of the image pyramid for a given work unit, assuming a pyramid structure parallel to that of the image pyramid.

It is realized herein that a logic control block coupling the processing element to the various levels of the line buffer can facilitate the time sharing of the processing element cycles. As processing is completed for one level, the intermediate results are stored in the line buffer for that level and retrieved as input when processing for the next level begins. It is further realized herein that the logic control block may include one or more timing multiplexers configured to couple the appropriate level of the line buffer according to the processing flow through the image pyramid work unit. Such an arrangement does not preclude the use of block-linear memory architectures, which are common in graphics processing unit (GPU) architectures. Furthermore, it is realized herein the necessary line buffer allocations can actually be reduced with the block-linear memory architecture as the image is divided into smaller blocks that are processed separately.

It is also realized herein that the size of the work unit and, therefore, the number of cycles required to process the work unit depends on the ratio of pixels between adjacent levels and the number of levels in the image pyramid. Furthermore, the number of levels in the image pyramid depends on the size of the source image, which is generally the finest resolution level. For example, if an image pyramid has three levels and a sub-pixel ratio of four-to-one, a work unit would contain twenty-one pixels to be processed (1+4+16=21). The logic control block would allocate processing element cycles proportionally according to each level's fraction of the aggregate pixels ( 1/21, 4/21 and 16/21).

It is also realized herein the logic control block can support a fine-to-coarse or a coarse-to-fine image pyramid processing flow. In a fine-to-coarse processing flow for an image pyramid having a sub-pixel ratio of X-to-one (X:1), the work unit is processed such that once X pixels are processed at the finest level, one is processed at the second finest level; once X² pixels are processed at the finest level and X processed at the second finest level, one is processed at the third finest level; and once X³ pixels are processed at the finest level, X² pixels at the second finest and X pixels at the third, one is processed at the fourth finest level of the work unit. This series extends on up to the coarsest level of the image pyramid when the last pixel of the work unit is processed. Generally, to process a pixel on the N^{th} level of the image pyramid, the number of pixels that must first be processed beneath it can be expressed as:

X^{N-1}+X^{N-2}+X^{N-3}+ . . . +X²+X¹.

Conversely, in a coarse-to-fine processing flow for an image pyramid having a sub-pixel ratio of X-to-one (X:1), the work unit is processed such that processing any one pixel for any given level of the work unit is not complete until each of the X sub-pixels beneath it are complete. Generally, the number of sub-pixels beneath a given pixel on the N^{th} level of the image pyramid can be expressed the same as above. The distinction between a fine-to-coarse and coarse-to-fine processing flow is that a super-pixel is processed before its sub-pixels in a coarse-to-fine processing flow. The opposite is true in a fine-to-coarse processing flow. In either case, the intermediate results of the earlier processed pixel are retrieved from the line buffer to employ in processing the next pixel of an adjacent level.

It is realized herein the necessary memory allocations in the time-sharing pipeline architecture are efficient with respect to cost, speed and power. The pyramid structure of the line buffer demands only an allocation sufficient to store intermediate results within a single work unit. It is realized herein the allocations are small enough to be made in SRAM, meaning the majority of memory traffic is to and from SRAM. It is further realized that reading and writing to main memory in DRAM is limited to retrieving the source image and storing the final processed image. SRAM tends to be more expensive than DRAM, however the speed and low power characteristics outweigh the cost, so long as the allocation is relatively small.

It is further realized herein the time-sharing pipeline architecture is scalable to meet the system's target throughput. The architecture can be duplicated many times to process an image in parallel, but with the same efficiencies discussed above.

Before describing various embodiments of the image pyramid processor or method of multi-resolution image processing introduced herein, a computing system within which the image pyramid processor or method of multi-resolution image processing may be embodied or carried out will be described.

FIG. 1 is a block diagram of a computing system 100 within which an image pyramid processor or method of multi-resolution image processing may be embodied or carried out. Computing system 100 includes a computer vision (CV) engine 102, a central processing unit (CPU) or graphics processing unit (GPU) 104 and dynamic random access memory (DRAM) 106. DRAM 106 contains an allocation of memory for main memory. Main memory may be written to or read from by CPU/GPU 104 and computer vision engine 102. CPU/GPU 104 and computer vision engine 102 are coupled to DRAM 106 and each other by a data bus.

This embodiment of computer vision engine 102 contains a processing engine pool 112 and a line buffer 108. In certain embodiments, line buffer 108 is implemented in static random access memory (SRAM). Line buffer 108 is allocated to each level of an image pyramid in a parallel pyramid manner. Within line buffer 108, buffer 114-0, 114-1, 114-2 and 114-3 are each successively smaller in size. Buffer 114-0 is allocated for the finest level of the image pyramid, buffer 114-1 is allocated for the next finest, buffer 114-2 for an even coarser level, and finally buffer 114-3 is allocated for the coarsest level.

Processing engine pool 112 includes a buffer control 110, a CV controller 116, a memory controller 118 and five processing elements: an add/subtract element 120-1, a convolution element 120-2, a saliency element 120-3, a descriptor generation element 120-4 and a motion estimation element 120-5. Other embodiments of processing engine pool 112 may include a variety of other processing elements, including: an image warping element, a look up table element, an arithmetic logic unit (ALU), feature detection and many others. These functions are functions that must be performed at all levels of the image pyramid.

CV controller 116 performs interface functions between CPU/GPU 104 and computer vision engine 102. Similarly, memory controller 118 performs interface functions between DRAM 106 and computer vision engine 102. Buffer control 110 operates as a multiplexer among processing engine pool 112 and the various line buffers, 114-0 through 114-3. For a given process to be carried out on computer vision engine 102, buffer control 110 operates as a timing multiplexer between the various levels of line buffer 108 and active processing elements of processing engine pool 112. Within a single work unit, active processing elements operate on data from each level of line buffer 108 in a time-shared manner, processing a single level proportionally according to its fraction of the aggregate pixels.

Having described a computing system within which the image pyramid processor or method of multi-resolution image processing introduced herein may be embodied or carried out, various embodiments of the image pyramid processor and method of multi-resolution image processing will be described.

FIG. 2 is a block diagram of one embodiment of an image pyramid processor 200. Image pyramid processor 200 includes a logic control block 202, a processing element 204 and SRAM 206. A line buffer 208 having four buffer allocations is allocated within SRAM 206. Each of the four buffers: buffer 210-0, 210-1, 210-2 and 210-3, correlates to the resolution levels of an image pyramid. Buffer 210-0 correlates to the starting resolution level, which may be the coarsest or finest level depending on whether the computer vision processing being carried out requires a coarse-to-fine or a fine-to-coarse process flow, respectively. In embodiments structured for coarse-to-fine, buffer 210-0 correlates to the coarsest level and buffers 210-1, 210-2 and 210-3 each correlate to successively finer levels of the image pyramid. In other embodiments, structured for fine-to-coarse processing, buffer 210-0 correlates to the finest level and buffers 210-1, 210-2 and 210-3 each correlate to successively coarser levels of the image pyramid.

Logic control block 202 couples processing element 204 to line buffer 208, specifically to buffers 210-0, 210-1, 210-2 and 210-3, in a time sharing manner. Processing element 204 processes an image pyramid comprised of a series of work units. Work units are processed sequentially, processing any given work unit completely before moving on to the next. A work unit includes a single pixel in the coarsest level of the image pyramid and each sub-pixel beneath. As such, the work unit spans all resolution levels of the image pyramid. This construction of the image pyramid provides for an interleaving among the resolution levels and results in improved latency in image pyramid processing over segmented pipeline architectures that process the far extents of a given pyramid level before processing pixels of immediate interest in adjacent pyramid levels. Processing element 204 operates on a single pixel in the work unit per processing cycle. The work unit is processed over the course of a set of processing cycles allocated proportionally according to each resolution level's fraction of the aggregate pixels.

FIG. 3 is an illustration of one embodiment of a work unit within an image pyramid 300. Image pyramid 300 is a pyramid representation of starting image 302. Image pyramid 300 includes four resolution levels, each level being four times the resolution of the level immediately above. Image pyramid 300 is an example of a coarse-to-fine image pyramid, where starting image 302 is the coarsest representation, and each sub-level is up-sampled from the level above. In alternate embodiments of image pyramids, starting image 302 is the finest representation, or “source image,” and each sub-level constitutes a reduction in resolution, or is down-sampled.

In the embodiment of FIG. 3, a pixel 304 of starting image 302 is the starting point for a work unit that spans each of the four levels of image pyramid 300. Pixel 304 is in the starting level, otherwise known as level zero. Once pixel 304 is up-sampled to level one 306, the resolution quadruples. Within the work unit of pixel 304, level one 306 contains four pixels. Once level one 306 is up-sampled to level two 308, the resolution quadruples again, and again for level three 310. In the four levels of the work unit of pixel 304, there is pixel 304 at level zero, four pixels at level one 306, sixteen pixels at level two 308 and sixty-four pixels at level three 310. The size of the work unit is therefore eighty-five pixels (1+4+16+64=85). In alternate embodiments, the ratio of resolutions between levels may vary from just over one-to-one on up. For example, certain embodiments may up-sample by a factor of the square root of two, while others may use a factor of ten. The practical ramification of the ratio is that larger ratios require an exponentially larger segment of memory in the finer levels, however there are fewer levels. Conversely, in embodiments where image pyramid 300 is fine-to-coarse, large down-sampling factors quickly degrade the detail of the source image.

Continuing the embodiment of FIG. 3, if image pyramid 300 of starting image 302 were to be fully expanded (beyond the work unit illustrated), level one 306 would have sixty-four pixels, or four sub-pixels per source pixel. Likewise, level two 308 would have 256 pixels and level three 310 would have 1024.

If the work unit of pixel 304 were to be processed by the image pyramid processor or multi-resolution image processing method introduced herein, the entire work unit would be processed before moving on to the next work unit of the pixel adjacent to pixel 304. The order in which the work unit is processed is recursive in nature. For instance, assume the lower right pixel at each level of the work unit is processed first. Pixel 304 would be processed, followed by pixel 312 on level one 306. Next, pixel 314 on level two 308 is processed, followed by the four light grey pixels 316 on level three 310, which completes the processing within pixel 314. Before proceeding to pixels adjacent to pixel 312 on level one 306, the three dark grey pixels adjacent to pixel 314 are processed in a similar manner. First a pixel on level two 308, then its four correlating sub-pixels on level three 310, and then back up to the next pixel on level two 308. This processing flow is sometimes referred to as a “depth first” process. In other words, on any level of image pyramid 300, no adjacent pixel is processed until all pixels beneath the current pixel have been processed.

FIG. 4 is a flow diagram of one embodiment of a method of multi-resolution image processing. The method begins at a start step 410. At a step 420 an operation is carried out on a pixel in a first resolution level of an image pyramid. The image pyramid may have many resolution levels, but at least two. Operations are carried out by a processing element configured to perform a relatively simple function such as addition, subtraction, convolution or many others. The processing element carries out a single operation per processing cycle, those cycles being triggered by a clock or some other similar enabling signal.

The operation carried out at step 420 on the pixel in the first resolution level is carried out during a first processing cycle and the results are stored in a pyramid buffer, or line buffer. The results are employed at a step 430 to carry out the operation on a pixel in a second resolution level of the image pyramid. This second pixel is related to the first and is operated on during a second processing cycle.

The relationship of the first pixel in the first resolution level and the second pixel in the second resolution level exists in one of two forms. In some embodiments, the first resolution level is a coarse, or low resolution, representation of the source image. Accordingly, the second resolution level is finer, or higher, resolution than the first. The pixel in the second resolution level is a sub-pixel of the pixel in the first resolution level. The sub-pixel is arrived at by up-sampling the pixel in the first resolution level. In other embodiments, the first resolution level is finer and the second resolution level is coarser. In these embodiments, the pixel in the first resolution level is a sub-pixel of the pixel in the second resolution level. The pixel in the second resolution level is arrived at by down-sampling the pixel in the first resolution level.

The line buffer is pyramid shaped in that it parallels the image pyramid with respect to the amount of memory allocated for each level of the pyramid. Lower resolution levels of the pyramid require less memory be allocated to the line buffer, while higher resolution levels require more. This is a necessary correlation as there are simply more pixels to store data for in the higher resolution levels. For example, in certain embodiments, a single pixel at the coarsest level of the image pyramid may contain four sub-pixels at the next finer level. Each of those four sub-pixels may then have four further sub-pixels on an even finer level. The ratio of resolutions between two adjacent levels is an adjustable parameter of the image pyramid. Certain implementations of image pyramids may have a ratio barely greater than one, while others may be significantly larger, such as eight-to-one or ten-to-one.

In alternate embodiments of the method of multi-resolution image processing, particularly those having image pyramids comprising more than two layers, the method processes recursively through each level of the image pyramid within a work unit. A work unit is as described above in FIG. 3, and is based on a single pixel at the coarsest level of the image pyramid. For example, if the pixel in the first resolution level were a pixel in the coarsest resolution level, then the method would further include a step employing the results of the operation carried out on the pixel in the second resolution level in carrying out the operation on a third pixel in a third resolution level. The operation on the first pixel is carried out during a first processing cycle, the second processing cycle for the second pixel, and the operation carried out on the third pixel would be carried out during a third processing cycle. This processing flow may be generalized for other embodiments having second, third and possibly more levels that are each successively coarser than the first resolution level. The method ends at an end step 440.

Whether the processing flows from coarse-to-fine or fine-to-coarse, with respect to any two adjacent levels of the image pyramid, all sub-pixels in the finer level of a pixel in the coarser level are processed before moving on to process another pixel adjacent to the pixel in the coarser level.

Those skilled in the art to which this application relates will appreciate that other and further additions, deletions, substitutions and modifications may be made to the described embodiments.

What is claimed is:

1. An image pyramid processor, comprising:
a level multiplexer configured to employ a single processing element to process multiple levels of an image pyramid in a single work unit; and
a buffer pyramid having memory allocable to store respective intermediate results of said single work unit.

2. The image pyramid processor recited in claim 1 wherein said buffer pyramid is allocable in static random access memory.

3. The image pyramid processor recited in claim 1 wherein said level multiplexer employs a timing multiplexer.

4. The image pyramid processor recited in claim 1 wherein said image pyramid comprises three successively higher resolution levels.

5. The image pyramid processor recited in claim 1 wherein said single work unit includes a pixel and each sub-pixel composing said pixel at said multiple levels of said image pyramid.

6. The image pyramid processor recited in claim 1 wherein said single processing element carries out an atomic computer vision function.

7. The image pyramid processor recited in claim 6 wherein said atomic computer vision function is a convolution function.

8. A method of multi-resolution image processing, comprising:
carrying out an operation on a first resolution level pixel of an image pyramid during a first processing cycle and storing results in a pyramid buffer; and
employing said results in carrying out said operation on a second resolution level pixel related to said first resolution level pixel during a second processing cycle.

9. The method recited in claim 8 wherein said first resolution level pixel is a higher resolution pixel relative to said second resolution level pixel.

10. The method recited in claim 9 wherein said second resolution level pixel is a lower resolution pixel and comprises four sub-pixels, one of which is said higher resolution pixel.

11. The method recited in claim 8 further comprising:
storing second resolution level results of carrying out said operation on said second resolution level pixel in said pyramid buffer; and
employing said second resolution level results in carrying out said operation on a third resolution level pixel related to said second resolution level pixel during a third processing cycle.

12. The method recited in claim 8 wherein said first processing cycle and said second processing cycle are of equal duration.

13. The method recited in claim 8 further comprising allocating said pyramid buffer in static random access memory.

14. The method recited in claim 8 wherein said carrying out said operation includes performing a motion estimation.

15. A computer vision engine, comprising:
a processing engine pool having a processing element operable to carry out an operation on pixels within a multi-level work unit of an image pyramid;
a control block configured to direct said processing element to process said multi-level work unit completely before processing another multi-level work unit; and
a buffer pyramid configured to store respective intermediate results generated by said processing element.

16. The computer vision engine recited in claim 15 wherein said multi-level work unit comprises:
a single pixel at a first resolution level;
four pixels at a second resolution level; and
sixteen pixels at a third resolution level.

17. The computer vision engine recited in claim 15 wherein said control block is operable to direct said processing element to:
retrieve said intermediate results of a higher resolution level from said buffer pyramid; and
employ said intermediate results to process a lower resolution level within said multi-level work unit.

18. The computer vision engine recited in claim 15 further comprising a main memory configured to store input image pyramid data employable to process a lowest resolution level of said image pyramid and output image pyramid data generated by processing a highest resolution level of said image pyramid.

19. The computer vision engine recited in claim 15 wherein said pyramid buffer is allocable in static random access memory (SRAM).

20. The computer vision engine recited in claim 15 wherein said operation is an addition function.
